(19) United States
(12) Patent Application Publication
(10) Pub. No.: US 2018/0144110 A1
(43) Pub. Date: May 24, 2018

(54) MULTI-INPUT USER INTERACTION AND BEHAVIORAL BASED AUTHENTICATION SYSTEM FOR CONTEXT AWARE APPLICATIONS

(71) Applicant: International Business Machines Corporation, Armonk, NY (US)

(72) Inventors: Thomas E. Creamer, Boca Raton, FL (US); Erik H. Katzen, Argyle, TX (US); Sumit Patel, Irving, TX (US)

(21) Appl. No.: 15/358,522

(22) Filed: Nov. 22, 2016

(51) Int. Cl. G06F 21/31; G06F 21/55; G06F 21/81; G06F 21/62; H04W 12/06; H04L 29/08

(52) U.S. Cl. CPC G06F 21/316; G06F 21/554; G06F 21/81; G06F 2221/2113; H04W 12/06; H04L 67/306; G06F 21/6245

(57) ABSTRACT

A mobile device which can identify a change in possession of the device and based on a change in possession of the device implement different types of security protocols to follow based on a scoring system regarding threat of the user to the data on the mobile device.

### BACKGROUND

The present invention relates to authentication systems, and more specifically to a multi-input user interaction and behavioral based authentication system for context aware applications.

The pervasiveness of applications and interconnected systems has made password management difficult as entities seek to ensure secure interactions through complex requirements such as length requirements, reuse restrictions, etc. The need to ensure security is paramount, but existing security solutions ignore usability, causing inconveniences which ultimately cause users to disable these solutions entirely. For example, a user may have two-factor authentication set up for their social media applications. On average, a user checks these applications 14 times a day so constantly entering a pin gets tiring, often this will lead to the user disabling this two-factor authentication and putting their personal content at risk.

The problem at hand can be further explained through a use case. User A is logged into their applications on their mobile device for convenience. User A does not want to enter their credentials when they use an application. However, when User A hands off the mobile device to User B for any reason (including borrowing a phone to make a call), then User B has access to all of User A's applications with no credentials required to be entered.

Existing security solutions focus on location only, elements of user interaction are not taken into account.

### SUMMARY

According to one embodiment of the present invention, a method for determining security threats to a device based on user usage of the device is disclosed. The device comprising a computer receiving input from a plurality of sensors regarding user usage of the device. The method comprising the steps of: the computer continuously checking user behavior in context to the device to determine user usage; the computer comparing the user usage to an established primary user profile and other associated profiles of the device to determine if the user behavior matches a profile; if the user behavior matches a profile other than the established primary user profile, the computer assessing a threat score; and if the threat score is greater than a first threshold, the computer preventing a user from accessing determined features of the device and enabling secondary authentication to access the determined features of the device.

According to another embodiment of the present invention a computer program product for determining security threats to a device based on user usage of the device. The device comprising a computer comprising at least one processor, one or more memories, one or more computer readable storage media, and receiving input from a plurality of sensors regarding user usage of the device, the computer program product comprising a computer readable storage medium having program instructions embodied therewith. The program instructions executable by the computer to perform a method comprising: continuously checking, by the computer, user behavior in context to the device to determine user usage; comparing, by the computer, the user usage to an established primary user profile and other associated profiles of the device to determine if the user behavior matches a profile; if the user behavior matches a profile other than the established primary user profile, assessing, by the computer, a threat score; and if the threat score is greater than a first threshold, preventing, by the computer, a user from accessing determined features of the device and enabling secondary authentication to access the determined features of the device.

According to another embodiment of the present invention a computer system for determining security threats to a device based on user usage of the device. The device comprising a computer comprising at least one processor, one or more memories, one or more computer readable storage media having program instructions executable by the computer to perform the program instructions, and receiving input from a plurality of sensors regarding user usage of the device. The program instructions comprising: continuously checking, by the computer, user behavior in context to the device to determine user usage; comparing, by the computer, the user usage to an established primary user profile and other associated profiles of the device to determine if the user behavior matches a profile; if the user behavior matches a profile other than the established primary user profile, assessing, by the computer, a threat score; and if the threat score is greater than a first threshold, preventing, by the computer, a user from accessing determined features of the device and enabling secondary authentication to access the determined features of the device.

### BRIEF DESCRIPTION OF THE DRAWINGS

FIG. 1 depicts an exemplary diagram of a possible data processing environment in which illustrative embodiments may be implemented.

FIG. 2 shows a schematic of a user-device behavioral context system.

FIG. 3 shows a flow diagram of a method of establishing profiles.

FIG. 4 shows a flow diagram of monitoring usage of a device for security threats.

FIG. 5 depicts an exemplary diagram of a possible data processing environment in which illustrative embodiments may be implemented.

### DETAILED DESCRIPTION

It should be noted that in the present application the term “context” refers to the specific sets of behaviors within a pre-existing context set (such as location), this includes who is currently using the application/device, where is the application/device being used, what is being done on the application/device (i.e. accessing a secure banking application versus an application to hail a taxi).

In an embodiment of the present invention, a system is disclosed which allows multiple inputs to be leveraged to create a dynamic security solution which seamlessly blends into the user's daily application/device usage habits.

In an embodiment of the present invention, it is determined when a primary user of a mobile device is not the one interacting with the device itself. When this happens, additional security protocols may be implemented during the other user's interaction with the mobile device. This enables the convenience of a first user, for example User A, to access applications on the mobile device without the extra security features while still protecting User A from security breaches from other users, such as User B. Based on environmental cues, certain applications on the mobile device as well as features of the mobile device itself (camera etc.) may be locked or may prevent other users from interacting with the applications or features of the mobile device when the intended user or primary user (User A) is not the one using the mobile device. In an embodiment of the present invention, the mobile device is able to identify a change in possession of the device as well as different types of security protocols to follow based on a scoring system.

The features of the device may be physical features of the mobile device (i.e. camera) or associated with software present on the mobile device. A feature is defined as a distinguishing characteristic of a software item (e.g., performance, portability, or functionality).

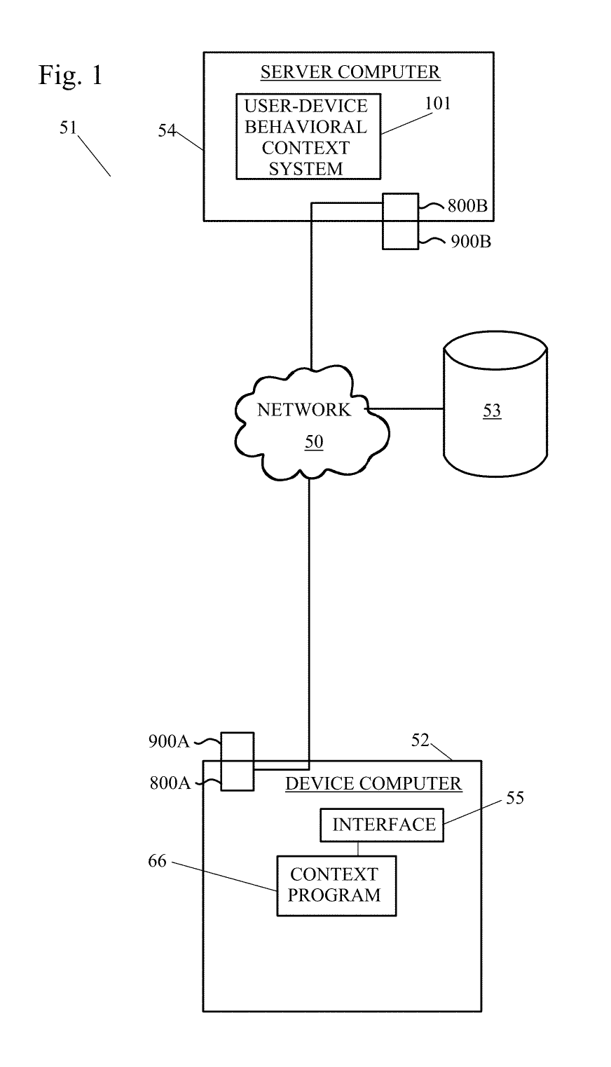

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, device computer 52, a repository 53, and a server computer 54 connect to network 50. In other exemplary embodiments, network data processing system 51 may include additional client or device computers, storage devices or repositories, server computers, and other devices not shown.

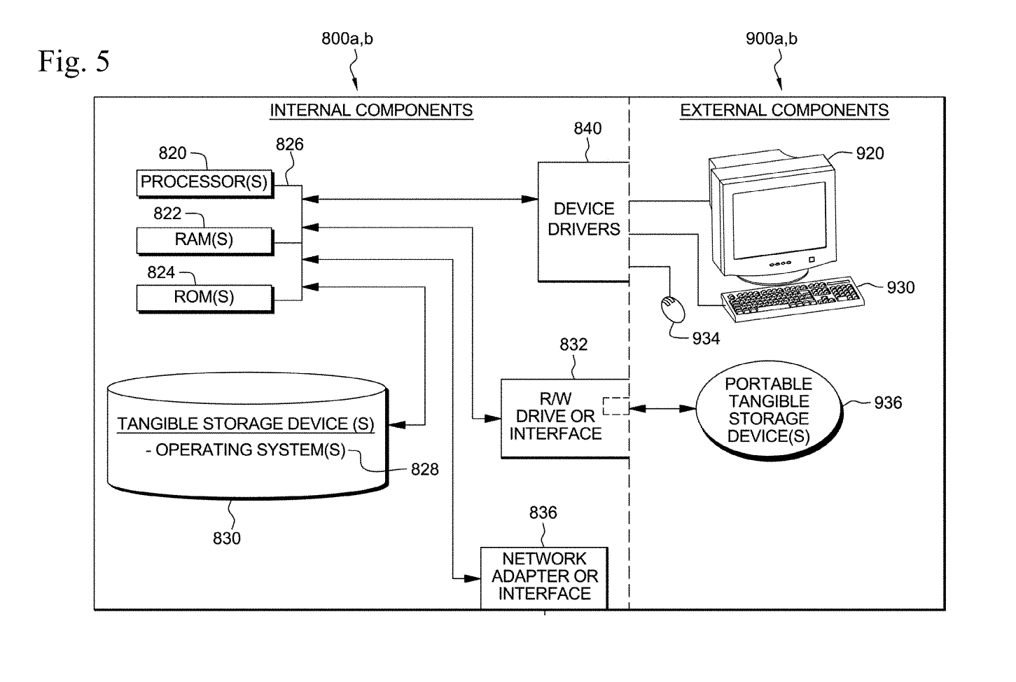

The device computer 52 may be a mobile device, a personal device, personal computer and tablet. The device computer 52 may contain an interface 55, which may accept commands and data entry from a user. The commands may be regarding security measures to be implemented for certain user profiles. The interface 55 can be, for example, a command line interface, a graphical user interface (GUI), a natural user interface (NUI) or a touch user interface (TUI). The device computer 52 preferably includes a context program 66. While not shown, it may be desirable to have the context program 66 be present on the server computer 54. The device computer 52 includes a set of internal components 800a and a set of external components 900a, further illustrated in FIG. 5.

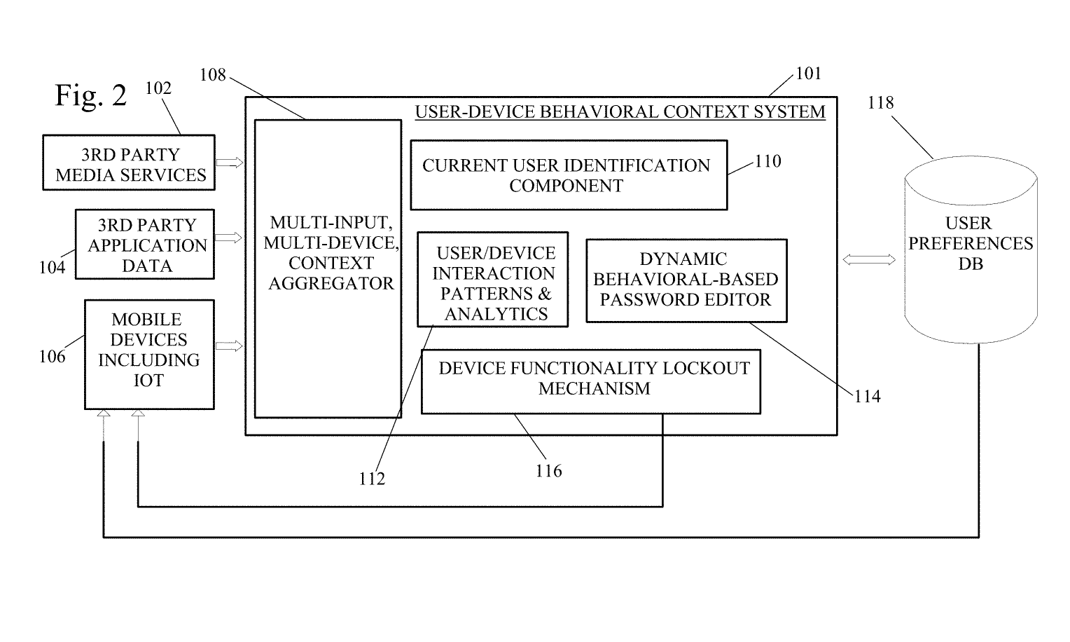

Server computer 54 includes a set of internal components 800b and a set of external components 900b illustrated in FIG. 5. In the depicted example, server computer 54 provides information, such as boot files, operating system images, and applications to the device computer 52. The server computer 54 may include a user-device behavioral context system 101. Additional details regarding this system are shown in FIG. 2. Server computer 54 can compute the information locally or extract the information from other computers on network 50. The server computer 54 may also contain the context program 66.

It should be noted that the user-device behavioral context system may also be present on the device computer 52.

Program code and programs such as context program 66 may be stored on at least one of one or more computer-readable tangible storage devices 830 shown in FIG. 5, on at least one of one or more portable computer-readable tangible storage devices 936 as shown in FIG. 5, or on storage unit 53 connected to network 50, or may be downloaded to a device computer 52 or server computer 54, for use. For example, program code and programs such as context program 66 may be stored on at least one of one or more storage devices 830 on server computer 54 and downloaded to device computer 52 over network 50 for use. Alternatively, server computer 54 can be a web server, and the program code, and programs such as context program 66 may be stored on at least one of the one or more storage devices 830 on server computer 54 and accessed device computer 52. In other exemplary embodiments, the program code, and programs such as context program 66 may be stored on at least one of one or more computer-readable storage devices 830 on device computer 52 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

In the description below, a mobile device is referred to, but it would be understood by a person skilled in the art that the device could be any device such as a personal computer, a personal device, a tablet, etc.

FIG. 2 shows a schematic of a user-device behavioral context system 101.

The user-device behavioral context system 101 can prompt the user with increased security measures when needed or automatically bypass the security measures when it is has been established that additional protocols are not required. For example, when a user checks into a public place (coffee shop, concert hall, etc.) via social media versus an alternative which may be home or work which is deemed to have a decreased threat). The checking in via social media to a public place may trigger increased security measures.

Inputs of at least third party social media services 102, third party application data 104 as well as an input of Internet of Things (IOT) of a mobile device 106 is provided as input to a multi-input, multi-device context aggregator 108 which generates a profile or log that details how devices and applications are used by users of the mobile device (e.g. Monday: check e-mail 5 AM; check social media at 5:05 AM, etc). The third party data may include, but is not limited to, textual content including short message service (SMS) and social media posts, emotion capture data using devices such as smart glasses, data from voice synthesis coupled to the mobile device; data from sound recordings of the environment, network traffic, and data from general IoT devices such as heart rate monitors, fitness trackers, etc.

Input may also be provided to the multi-input, multi-device context aggregator 108 from a global positing system (GPS) to provide location of a user which can be used by the user-device behavioral context system 101 to determine whether the user is in a public place where additional security measures may need to be triggered. Additional input such as sound levels present within the environment may be recorded by a microphone of the mobile device 106 to provide insight into the location of the user with the mobile device 106. For example, the user-device behavioral context system 101, based on context of the user's environment and based on information learned from the Multi-Input, Multi-Device Context Aggregator Component 108 may determine that when the sound levels exceed a threshold, the user is not a home or work and therefore is in a public area and additional security measures should be triggered.

These same inputs can be leveraged to manage application or device specific capabilities and permissions. One example is view only access on websites where credit information is stored versus the ability to actually make purchases.

The user/device interaction patterns and analytics component 112 compares user interactions with a device and associated application to the profile generated as well as earlier behaviors by the user to generate a threat score. This component 112 seeks to understand how a user interacts and behaves with each application and/or device within a given context to determine patterns and/or likely patterns of behavior.

As the primary user of a mobile device uses the device, the Current User Identification Component 110 uses information from the analytics component 112 to start to learn who is using the device at any given time. The input that the context system takes into consideration to form a profile on the primary user includes, but is not limited to: the angle of the screen with which the user holds the phone relative to the ground; the pressure that the user exerts while holding the phone (tight grip or loose grip); how the user holds the phone in general (two hands versus one hand w/pinky on the bottom); user's left and right handed device hold/grip/pressure/interaction patterns; the size of the fingerprint, or even the fingerprint itself, left when interacting with the screen; portrait or landscape views for primary usage; facial recognition; and how a user interacts with the touch screen (i.e. thumbs only usage versus thumb and index finger usage versus using two fingers on one hand to zoom in/out versus using one finger on each hand to zoom in/out, etc.).

Based on context of the user's environment and based on information learned from the Multi-Input, Multi-Device Context Aggregator Component 108, the Dynamic Behavioral-based Password Editor 114 can query the user to determine whether the user is the primary user or not based on primary user behavior. For example, if a user visits the following websites on a given day: LinkedIn, IBM.com, and CNN.com, the Dynamic Behavioral-based Password Editor 114 could pose queries to the current user, such as “What website did you not visit today?” to unlock various functionality. This interaction may also be complementary to the Device Functionality Lockout Mechanism Component 116. If the current user cannot answer the queries posed, the Device Functionality Lockout Mechanism Component 116 can lock specific applications on the mobile device to prevent the current user from accessing data the primary user wishes to keep private.

Profiles for multiple users of the mobile device may be manually created by a user or automatically created and enhanced over time by the input received from the multi-input, multi-device context aggregator 108 and user/device interaction patterns and analytics component 112. Each of the profiles may include specific protocols for each of the users which may use the mobile device. The profiles created for more than one user may be stored in a User Preferences Database 118. This ensures that shared devices can handle multiple users who need to access the devices for different means. These profiles can be downloaded to additional devices as needed (i.e. a user profile created for a smartphone, and can be downloaded for another mobile device owned by a user, such as a tablet).

For example: User A has all applications on their mobile device set to require no authentication to increase usage convenience. These security protocols are user defined and are compatible with the user-device behavioral context system 101. User A lets User B borrow the mobile device to make a phone call. The user-device behavioral context system 101 determines that User A is no longer controlling the device and accesses the environment and associated context and assigns a threat score based on User B interacting with the mobile device. Based on the threat score, the user-device behavioral context system 101 changes the security on the mobile device. For instance, the threat score is a 0.5 on a scale of [0,1] and therefore all finance applications are locked on the phone and require facial recognition to access. However, other non-critical applications (such as a maps application) remain unlocked.

Understanding the greater context of the user's environment can also create adaptive authentication scenarios involving questions such as “What was the name of the movie you just saw?” These same context authentication methods can be shared across a user's devices by leveraging IoT technologies. For example, User A signs up and logs into a website on their laptop at home and signals to the system ‘automatically sign-on when at home office for all devices’. User A will immediately be able to pull out their phone and log into the same website without entering the log-in credentials.

The user-device behavioral context system 101 is capable of learning user habits which will enable the system to predict user habits in the future.

The user-device behavioral context system 101 integrates and understands the user's daily routines to enact security policies that will ensure greater likelihood of these policies being used consistently. In other words, the user-device behavioral context system “learns” what is normal and what is not for the primary user of the device.

By leveraging inputs which are readily available, policies are dynamically enacted allowing a proactive determination of potential risks (i.e. a phone is more likely to be stolen when at a concert versus a restaurant meaning additional precautions are needed).

The user-device behavioral context system 101 allows users to be more comfortable sharing their devices in social settings since application or device specific authorizations can be set for other potential users.

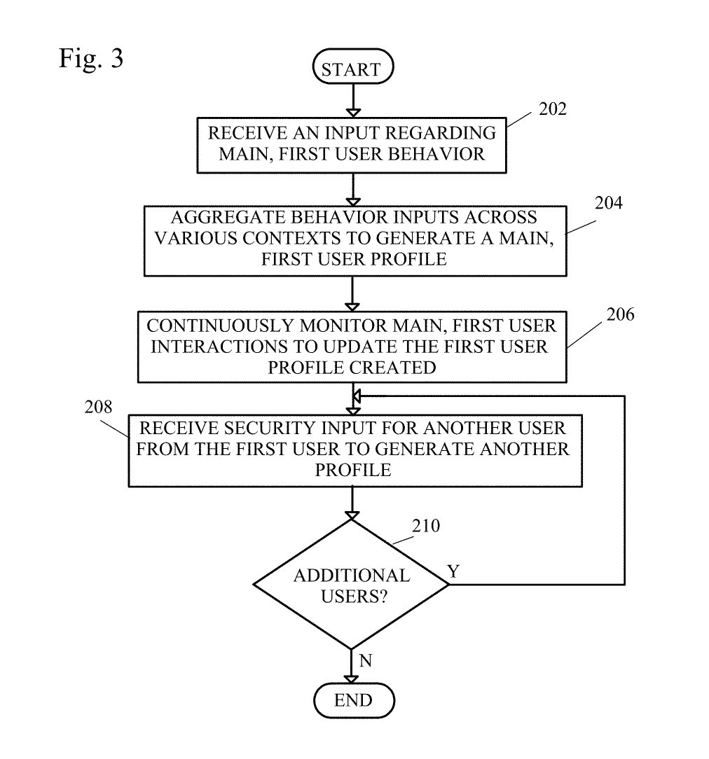

FIG. 3 shows a flow diagram of a method of establishing profiles.

In a first step, a context program 66 receives an input regarding a main, first user behavior (step 202). The main, first user or first user (referred to as User A in the examples) is the owner of the device or may be the user that uses the device a majority of the time. The input may include what applications on the mobile device or what features of the mobile device are to be locked when the first user is not using the device.

Behaviors input across various contexts are aggregated to generate a main, first user profile through analysis of the behavior input (step 204).

The context program 66 continuously monitors the main, first user interactions to update the first user profile created (step 206).

The context program 66 receives a security input for a second user (User B or C, etc.) from the first user to generate a profile (step 208). The profile of the second user may be updated to include behavior of the second user when the second user uses the mobile device.

For all additional users other than the main, first user (step 210), the method repeats step 208. When no additional users are present (step 210), the method ends.

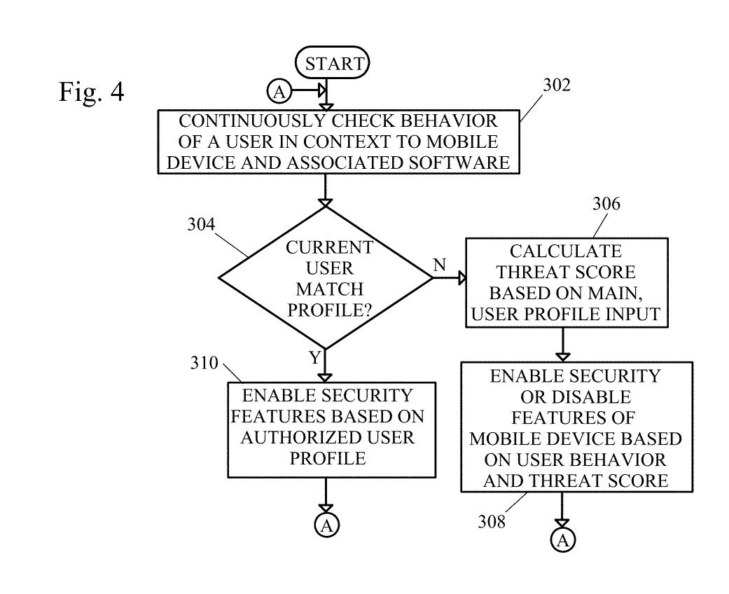

FIG. 4 shows a flow diagram of monitoring usage of a device for security threats.

In a first step, the context program 66 continuously checks behaviors of a user in context to the mobile device and associated software (step 302).

If the current user of the mobile device matches a user profile (step 304), the context program 66 enables additional security features based on the authorized user profile (step 310) and the method returns to step 302.

If the current user of the mobile device does not match a user profile (step 304), the context program 66 calculates a threat score in reference to the main user profile input (step 306) and enables or disables the software and features of the mobile device based on the user behavior and threat score (step 308) and the method returns to step 302.

A confidence rating can be calculating and used to generate an estimate of doubt (degree of confidence) regarding whether a current user of the mobile device is the user of a user profile (i.e. the actions taken by User X are 90% similar to the actions taken by the user for Profile A). When the confidence rating is greater than a threshold, user X is classified as a match to Profile A.

For example, if User A owns a mobile device and User B is a relative of User A, User A can set up User B as a secondary user of the mobile device. User A setups their settings on the mobile device to enable the user-device behavioral context system 101 to create profiles automatically. User A specifies default security settings for additional users as well. As User A uses the mobile device, the user-device behavioral context system 101 captures profiling inputs and stores the input for the profiles under User A's profile. When the user-device behavioral context system 101 determines that User A is using the mobile device with a strong degree of confidence, then the security settings for User A are enabled. The degree of confidence is based on the confidence rating when the system 101 determines that User A is the most likely user.

Now, User A enables a profile for User B. User A specifies certain permissions for User B and sets up the security protocols. Then User A lets User B use the mobile device, so the automated aspect of the Profiling Inputs can be used to enhance User B's profile. In this regard, User B's profile is both manually created and automatically updated. Finally, the user-device behavioral context system 101 is capable of determining when User A is using the mobile device, when User B is using the mobile device, and when a User C (an unauthorized user) is using the mobile device based on the profile of all authorized users compared against the Profiling Input.

Once the profiles of the users are set up, then the user-device behavioral context system 101 enters a mode to continuously check to determine whether or not an authorized user is using the mobile device. The algorithms of the present invention are based on the Profiling Input due to the fact that, with a larger body of knowledge and input, the user-device behavioral context system 101 can assign a confidence rating.

If the user-device behavioral context system 101 does not detect a match between the current user and a profile, the user-device behavioral context system 101 enters a threat mode. A threat score is assigned to the current user based on the Profiling Input and the user behavior. The user-device behavioral context system 101 starts to require additional security protocols based on the security defined in the primary user's (User A) profile. This is accomplished using the Device Functionality Lockout Mechanism Component 116. For instance, User A can specify that all financial applications be shutdown when a threat score is above 0.2 on a scale of [0,1], with 1 being high. When the threat score reaches 0.5, then all social media applications lock down, utilizing a tiered system of thresholds to determine whether additional security protocols are required.

When a score of 0.9 is reached, then the phone locks down completely. These levels can be manually defined by the user or automatically defined based on best practices.

At this point, when User A hands off the mobile device to User C to borrow for a phone call, the system might determine a threat score of 0.2 because User C's Profiling Input does not match User A or User B. At this point, financial applications would be locked down, but User C could still use the phone call button. As User C begins to pry on social media and User C's behavior diverges from User A's behavior, then the threat score might increase to 0.5, thus locking User C out of social media. An example could include User C entering a derogatory status on a social media application which the user-device behavioral context system 101 could recognize before User C sends out the status update.

Finally, if User C tries to break into User A's phone intentionally, as opposed to just “borrowing” it for a phone call, then the threat score would increase to 0.9 based on User C's behavior and the mobile device would shut down completely.

Examples of system input responses which aid in identifying a user to a specific user profile of a mobile device are discussed below.

In an example of an Android based operating system of a mobile device, the angle of the screen with which the user holds the phone relative to the ground may be used, such as TYPE_ORIENTATION in which a computer of the mobile device measures degrees of rotation that a device makes around all three physical axes (x, y, z). The inclination matrix and rotation matrix for the device may be determined by using a gravity sensor and a geomagnetic field sensor in conjunction with thegetRotationMatrix( ) method to determine the position of the mobile device.

In another example, a Core Motion framework is primarily responsible for accessing raw accelerometer and gyroscope data and passing that data to an app for handling. Core Motion uses unique algorithms to process the raw data it collects, so that it can present more refined information. This processing occurs on the framework's own thread.

Core Motion is distinct from UIKit. It is not connected with the UIEvent model and does not use a responder chain. Instead, Core Motion simply delivers motion events directly to apps that request them.

Core Motion events are represented by three data objects, each encapsulating one or more measurements: a CMAccelerometerData object captures the acceleration along each of the spatial axes; a CMGyroData object captures the rate of rotation around each of the three spatial axes; and a CMDeviceMotion object encapsulates several different measurements, including altitude and more useful measurements of rotation rate and acceleration.

The pressure that the user exerts while holding the phone (tight grip or loose grip) is another input that could be measured.

While touch and pressure is measured on touch displays currently, the same or similar methods could be used to measure the pressure of a user's grip on the mobile device. Pressure applied to a specific interface of the device, such as button may also be measured and accessed via an application program interface. It should noted that casings with glass (versus aluminum or plastic) are the current basis for touch pressure measurement today.

Capacitive sensors may also be integrated into the backlight of a Retina HD display. When the screen is pressed, those sensors measure the space between the cover glass and the backlight. Combined with the touch sensor and the mobile device's accelerometer, these provide the continuous response to the finger pressure, for example, how the user holds the phone in general (two hands versus one hand w/pinky on the bottom). In another example, the same sensors may also be used to sense whether the grip and finger placement is similar (or possibly the same) between the users, such as whether a User's left and right handed device hold/grip/pressure/interaction patterns are similar.

Accessories such as dimple that are third party buttons (https://dimple.io/) can also be used by comparing usage data (similar to the pattern comment above using the dimple SDK). For example, User A uses the third button (which is linked to his messages) every day. When a new user picks up the device and the third button has not been pressed in over 30 minutes, camera recognition is triggered to see if User A is no longer using the phone.

The size of the fingerprint, or even the fingerprint itself, left when interacting with the screen may additionally be used with the user's profile. For example, it would be easy to determine a large male finger versus a small female finger.

Additionally, continuous monitoring of fingerprints including size and placement using the manufacturer's SDK may be used to detect whether the mobile device is in portrait or landscape views for primary usage. This is a minor predictor of user ID but it is able to work with other measures to determine one input into predicting usage pattern. Other inputs such as how a user interacts with the touch screen (i.e. thumbs only usage versus thumb and index finger usage versus using two fingers on one hand to zoom in/out versus using one finger on each hand to zoom in/out, etc.) may also be used as input.

Embedded fingerprint scanners within the screen of a mobile device may be able to differentiate the actual finger being used to interact with the device. While the phone may not lock out a new user with a different set of fingerprints, the data related to the type of finger using the device can be compared with the historic information (i.e. current session has an index finger actively interacting with 30% of the lower right portion of the screen, historical sessions involve a thumb interacting with the middle 50% of the screen—use existing confidence algorithms to determine a confidence rating of the whether a user match or mismatch is applicable and apply relevant security policies).

FIG. 5 illustrates internal and external components of a device computer 52 and server computer 54 in which illustrative embodiments may be implemented. In FIG. 5, a device computer 52 and a server computer 54 include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and context program 66 are stored on one or more of the computer-readable tangible storage devices 830 for execution by one or more of the processors 820 via one or more of the RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Context program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Context program 66 can be downloaded to the device computer 52 and server computer 54 from an external computer via a network (for example, the Internet, a local area network or other, wide area network) and network adapter or interface 836. From the network adapter or interface 836, context program 66 is loaded into hard drive 830. Context program 66 can be downloaded to the server computer 54 from an external computer via a network (for example, the Internet, a local area network or other, wide area network) and network adapter or interface 836. From the network adapter or interface 836, context program 66 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Context program 66 can be written in various programming languages including low-level, high-level, object-oriented or non object-oriented languages. Alternatively, the functions of a context program 66 can be implemented in whole or in part by computer circuits and other hardware (not shown).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for determining security threats to a device based on user usage of the device, the device comprising a computer receiving input from a plurality of sensors regarding user usage of the device, the method comprising the steps of:
the computer continuously checking user behavior in context to the device to determine user usage;
the computer comparing the user usage to an established primary user profile and other associated profiles of the device to determine if the user behavior matches a profile;
if the user behavior matches a profile other than the established primary user profile, the computer assessing a threat score; and
if the threat score is greater than a first threshold, the computer preventing a user from accessing determined features of the device and enabling secondary authentication to access the determined features of the device.

2. The method of claim 1, wherein if the threat score is greater than a second threshold, the computer shutting down the device for use.

3. The method of claim 1, wherein the secondary authentication is based on prior user behavior associated with the associated profiles.

4. The method of claim 1, wherein determined features which are inaccessible are related to personal information of the primary user.

5. The method of claim 1, wherein the primary user profile is created by usage of the device over a period of time.

6. The method of claim 1, wherein the device is a mobile phone and the determined features of the device that are inaccessible if the threat score is greater than the first threshold are applications comprising financial data and application comprising personal information regarding the user.

7. The method of claim 1, wherein the device is a mobile phone and the determined features of the device that are inaccessible if the threat score is greater than a first threshold are applications associated with social media.

8. A computer program product for determining security threats to a device based on user usage of the device, the device comprising a computer comprising at least one processor, one or more memories, one or more computer readable storage media, and receiving input from a plurality of sensors regarding user usage of the device, the computer program product comprising a computer readable storage medium having program instructions embodied therewith, the program instructions executable by the computer to perform a method comprising:
continuously checking, by the computer, user behavior in context to the device to determine user usage;
comparing, by the computer, the user usage to an established primary user profile and other associated profiles of the device to determine if the user behavior matches a profile;
if the user behavior matches a profile other than the established primary user profile, assessing, by the computer, a threat score; and
if the threat score is greater than a first threshold, preventing, by the computer, a user from accessing determined features of the device and enabling secondary authentication to access the determined features of the device.

9. The computer program product of claim 8, wherein if the threat score is greater than a second threshold, the computer shutting down the device for use.

10. The computer program product of claim 8, wherein the secondary authentication is based on prior user behavior associated with the associated profiles.

11. The computer program product of claim 8, wherein determined features which are inaccessible are related to personal information of the primary user.

12. The computer program product of claim 8, wherein the primary user profile is created by usage of the device over a period of time.

13. The computer program product of claim 8, wherein the device is a mobile phone and the determined features of the device that are inaccessible if the threat score is greater than the first threshold are applications comprising financial data and application comprising personal information regarding the user.

14. The computer program product of claim 8, wherein the device is a mobile phone and the determined features of the device that are inaccessible if the threat score is greater than a first threshold are applications associated with social media.

15. A computer system for determining security threats to a device based on user usage of the device, the device comprising a computer comprising at least one processor, one or more memories, one or more computer readable storage media having program instructions executable by the computer to perform the program instructions, and receiving input from a plurality of sensors regarding user usage of the device, the program instructions comprising:
continuously checking, by the computer, user behavior in context to the device to determine user usage;
comparing, by the computer, the user usage to an established primary user profile and other associated profiles of the device to determine if the user behavior matches a profile;
if the user behavior matches a profile other than the established primary user profile, assessing, by the computer, a threat score; and
if the threat score is greater than a first threshold, preventing, by the computer, a user from accessing determined features of the device and enabling secondary authentication to access the determined features of the device.

16. The computer system of claim 15, wherein if the threat score is greater than a second threshold, the computer shutting down the device for use.

17. The computer system of claim 15, wherein the secondary authentication is based on prior user behavior associated with the associated profiles.

18. The computer system of claim 15, wherein determined features which are inaccessible are related to personal information of the primary user.

19. The computer system of claim 15, wherein the primary user profile is created by usage of the device over a period of time.

20. The computer system of claim 13, wherein the device is a mobile phone and the determined features of the device that are inaccessible if the threat score is greater than the first threshold are applications comprising financial data and application comprising personal information regarding the user.
